(19) United States
(12) Patent Application Publication
(10) Pub. No.: US 2016/0172716 A1
(43) Pub. Date: Jun. 16, 2016

(54) ASSEMBLY FOR STORING ELECTRICAL ENERGY,COMPRISING A PRESSURE-INCREASING ACCELERATOR

(71) Applicant: BLUE SOLUTIONS, Ergue Gaberic (FR)

(72) Inventors: Eric Baylard, Le Relecq Kerhuon (FR); Thierry Drezen, Concarneau (FR)

(21) Appl. No.: 14/905,731

(22) PCT Filed: Jul. 15, 2014
(86) PCT No.: PCT/EP2014/065156

§ 371 Date: Jan. 15, 2016

(30) Foreign Application Priority Data
Jul. 16, 2013 (FR) 1356971

(51) Int. Cl. H01M 10/42; H01G 11/84; H01G 11/18; H01G 11/62; H01M 2/12; H01G 11/78

(52) U.S. Cl. CPC H01M 10/4235; H01M 2/1241; H01G 11/78; H01G 11/18; H01G 11/62; H01G 11/84; H01M 2220/20; H01M 2200/10; H01M 2200/20

(57) ABSTRACT

The invention relates to an assembly for storing electrical energy (1), comprising: an envelope comprising a body (10) having at least one side wall (11) and at least one open end, and at least one cover (20) for closing the at least one open end of the body; at least one energy storage element (50) arranged inside the envelope; and an electrolyte solution also inside the envelope. The invention is characterised in that the storage assembly also comprises: a pressure-increasing accelerator (40) for generating an overpressure inside the assembly when the temperature inside the assembly is higher than a temperature threshold, especially at between 120° C. and 140° C.; and means (30) for the local fracturing of the envelope when the pressure inside the envelope is higher than a pressure threshold.

### TECHNICAL FIELD

The present invention relates to the general technical field of assemblies for storing electrical energy.

Within the scope of the present invention, by “electrical energy storage assembly” is meant either a capacitor (i.e. a passive system comprising two electrodes and an insulator), or a supercapacitor (i.e. a system comprising at least two electrodes, an electrolyte and at least one separator), or a battery of the lithium battery type (i.e. a system comprising at least one anode, at least one cathode and an electrolyte between the anode and the cathode).

### GENERAL PRESENTATION OF THE PRIOR ART

An electrical energy storage assembly—for example of the supercapacitor type—conventionally comprises an envelope including a body such as a tubular element open at both of its ends, a capacitive winding and a liquid electrolyte inside the envelope. The assembly also comprises two lids for closing both ends of the body. Each lid is electrically connected to the capacitive winding.

Such an assembly may be used in many applications, like automotive applications.

When it is subject to high temperatures, for example because of a fire, the liquid electrolyte may evaporate, this evaporation inducing an increase in the pressure inside the assembly.

There is then a risk that the assembly explodes under the effect of the increase of its internal pressure.

In order to improve the safety of such an assembly, two solutions assumed to limit the risks of explosion are known, when the assembly is subject to high temperatures.

The first solution consists of forming an embrittled area in the envelope, notably the body. This embrittled area is intended to break when the pressure inside the assembly exceeds a threshold value.

The breakage of this embrittled area then induces the formation of a ventilation allowing the gas contained in the envelope to escape outside the assembly.

However, it was possible to see that this first solution was not satisfactory, the presence of an embrittled area not systematically avoiding the explosion of the assembly when it is subject to a fire.

Indeed, the quality of the mechanical strength of the connection of the lids on the body rapidly decreases under the effect of heat, so that certain parts (notably lids) of the assembly are violently ejected even before the embrittled area breaks.

A second solution consists of forming a through-orifice in the envelope, and of obstructing the orifice by means of a welded disc by using a metal for which the melting temperature is:
greater to the maximum temperature of operation of the assembly, and
less than the minimum temperature from which the mechanical strength of parts of the assembly degrades.

The operating principle of an assembly based on this second solution is the following. In the case of a fire, the pressure inside the assembly increases, and the metal weld made on the disc melts. The disc is detached from the envelope, leaving the orifice free. This orifice then allows degassing of the assembly. Risks of explosion of the assembly are thereby avoided.

Thus, with this second solution, the opening of the assembly is no longer only dependent on its internal pressure, but is also dependent on its temperature.

However, this second solution also has drawbacks.

Notably, the risks of explosion are not totally eradicated with this second solution. Indeed, it was seen that the disc positioned on the orifice did not always detach sufficiently rapidly.

Moreover, the steps for forming the orifice and for covering the orifice with a disc complexify the method for manufacturing such an assembly.

An object of the present invention is to provide an electrical energy storage assembly with which it is possible to overcome at least one of the aforementioned drawbacks.

### PRESENTATION OF THE INVENTION

For this purpose, the invention proposes an electrical energy storage assembly comprising:
an envelope including:
   a body having at least one side wall and at least one open end,
   at least one lid for closing said at least one open end of the body
at least one electrical storage element located inside the envelope, and
an electrolyte solution also inside the envelope, remarkable in that storage assembly further comprises:
means for locally breaking the envelope when the pressure inside the envelope is greater than a pressure threshold, and
an accelerator for raising pressure in order to generate an overpressure inside the assembly when the temperature inside the assembly is greater than a temperature threshold, the accelerator comprising at least one sealed housing, each housing containing at least one overpressure agent, said sealed housing(s) being configured so as to release said overpressure agent(s) when the temperature inside the assembly is greater than the temperature threshold and at least one wall of said housing being designed in a material for which the melting temperature is substantially equal to the temperature threshold.

The presence of a sealed housing gives the possibility of guaranteeing the confinement of the overpressure agent when the temperature inside the enclosure is less than the temperature threshold.

The use of a material for which the melting temperature is substantially equal to the temperature threshold gives the possibility of obtaining a pressure—raising accelerator without any electronic element—such as a temperature sensor—and therefore of obtaining a pressure-raising accelerator not consuming any electrical energy for ensuring its function,
the melting temperature of the material is comprised between 120° C. and 140° C.;
this range of melting temperatures gives the possibility of guaranteeing release of the overpressure agent for a temperature inside the assembly:
   greater than the operating temperature of the assembly and,
   less than the critical temperature of degradation of the quality of the mechanical connections of the assembly.

Advantageously, the temperature threshold is greater than the maximum operating temperature of the assembly. This gives the possibility of avoiding risks of undesired opening of the assembly. This temperature threshold may also be less than a critical temperature beyond which the quality of the mechanical connections of the assembly is degraded. Moreover, the pressure threshold is preferably less than a critical pressure beyond which the assembly risks exploding.

Preferably, the temperature threshold is comprised between 120° C. and 140° C.

The means for locally breaking the envelope may consist in a mechanically embrittled area of the envelope.

The presence of a pressure raising accelerator gives the possibility of breaking more rapidly this embrittled area.

Indeed, when the internal temperature of the assembly exceeds a temperature threshold, the accelerator generates an “additional” pressure P2 which will be added to the “natural” pressure P1 inside the assembly. The total pressure Ptot inside the assembly is then equal to the sum of the “natural” pressure P1 and of the “additional” pressure P2:

Ptot=P1+P2

This addition of “additional” pressure P2 induces an acceleration in the rise of pressure of the assembly. The total pressure Ptot then more rapidly exceeds a limiting pressure for breaking the embrittled area before the temperature reaches the critical temperature as mentioned earlier.

The embrittled area therefore breaks more rapidly than with solutions of the prior art, which allows discharge of the gases contained in the assembly before the latter explodes.

Another advantage of the invention is that it gives the possibility of reaching more rapid opening of the assembly without having an influence on its strength.

Indeed, in the case of the first solution described above, another option for reaching more rapid opening of the assembly may consist in further weakening the mechanically embrittled area. However, such an option would induce a decrease in the pressure from which the assembly opens at its operating temperature and therefore in the mechanical strength of the assembly making its use difficult in certain fields of application such as the automotive field.

Preferred but non-limiting aspects of the assembly according to the invention are the following:
the accelerator is capable of triggering a chemical reaction generating gas in the assembly when the temperature inside the assembly is greater than the temperature threshold;
this gives the possibility of simplifying the process for generating overpressure,
the accelerator is positioned inside the envelope, notably in a dead volume of the envelope (i.e., an unused space of the envelope).
In particular, the storage element placed in the envelope is wound so as to have a cylindrical shape and to have a central recess, the accelerator being placed in the recess;
this allows limitation in the dimension of the assembly and even insertion of an accelerator according to the invention without modifying the dimensions of the assembly,
said at least one wall delimiting said or one of the housings is in a plastic material selected from polypropylene, polyethylene, polycarbonate, polystyrene, polyoxymethylene, polyamide, polyester, polyurethane or an elastomer;
the housing is a hollow capsule including a head and a body fitted into each other, such as a gelatin capsule including a cylindrical head and body, each open at one end and the bottoms of which are for example hemispherical;
said overpressure agent(s) is (are) capable of generating a gas, selected from dihydrogen (H₂), carbon dioxide (CO₂) and dinitrogen (N₂), when they are released from the sealed housing(s). These gases are indeed non-toxic and non-polluting;
said overpressure agents(s) form(s) reagents selected for reacting with the electrolyte of the assembly. For example, the overpressure agent is water and the electrolyte comprises an ammonium salt (TEABF₄ or TEMABF₄ notably) in solution, the reaction of the salt with the water generating dihydrogen in the envelope;
alternatively, said or said at least one of the overpressure agents may react with a component of the electrode or with a separator of the storage element,
the assembly comprises a plurality of overpressure agents, located in a single housing or in different housings (materialized for example by a same capsule or two different capsules) selected so as to react together when they are placed in solution,
the plurality of overpressure agents comprises a first reagent including a carboxylic acid (R-COOH) and a second reagent based on carbonate (X₂CO₃) or bicarbonate (XHCO₃);
the means for locally breaking the envelope comprise a mechanically embrittled area intended to break when the pressure inside the assembly is above the pressure threshold;
the mechanically embrittled area is a boss or an edge or a region of the assembly for which the thickness is less than the thickness of the other regions of the assembly;
the means for locally breaking the envelope are localized on the side wall of the envelope, i.e. on the body.

The invention also relates to an electrical energy storage module including a casing, remarkable in that it comprises at least one electrical energy storage assembly as described above.

The invention also relates to a method for manufacturing an electrical energy storage assembly comprising:
an envelope including:
   a body having at least one side wall and at least one open end,
   at least one lid for closing at least one open end of the body,
at least one energy storage element placed inside the envelope,
an electrolyte solution also placed inside the envelope, and the method comprising the steps of:
associating a pressure raising accelerator with the assembly, notably by positioning the accelerator in the envelope, the accelerator allowing generation of overpressure inside the assembly when the temperature inside the assembly is greater than a temperature threshold, the accelerator comprising at least one sealed housing, each housing containing at least one overpressure agent, said sealed housing(s) being configured for releasing the overpressure agent(s) when the temperature inside the assembly is greater than the temperature threshold and at least one wall of said housing being designed in a material for which the melting temperature is substantially equal to the temperature threshold, and
forming means for locally breaking the envelope when the pressure inside the envelope is greater than a pressure threshold, notably by forming a mechanically embrittled area on the envelope.

### PRESENTATION OF THE FIGURES

Other features, objects and advantages of the present invention will further become apparent from the description which follows, which is purely illustrative and non-limiting and should be read with reference to the appended drawings wherein:

FIG. 1A illustrates a schematic illustration in a radial section of an electric energy storage assembly,

FIG. 1B illustrates a schematic axial sectional representation of the envelope of the assembly of FIG. 1A along A-A,

FIG. 2 illustrates an example of an accelerator for raising pressure of the assembly.

### DESCRIPTION OF THE INVENTION

Different embodiments of the invention will now be described with reference to the figures. In these different figures, equivalent elements bear the same numerical references.

### 1. Assembly

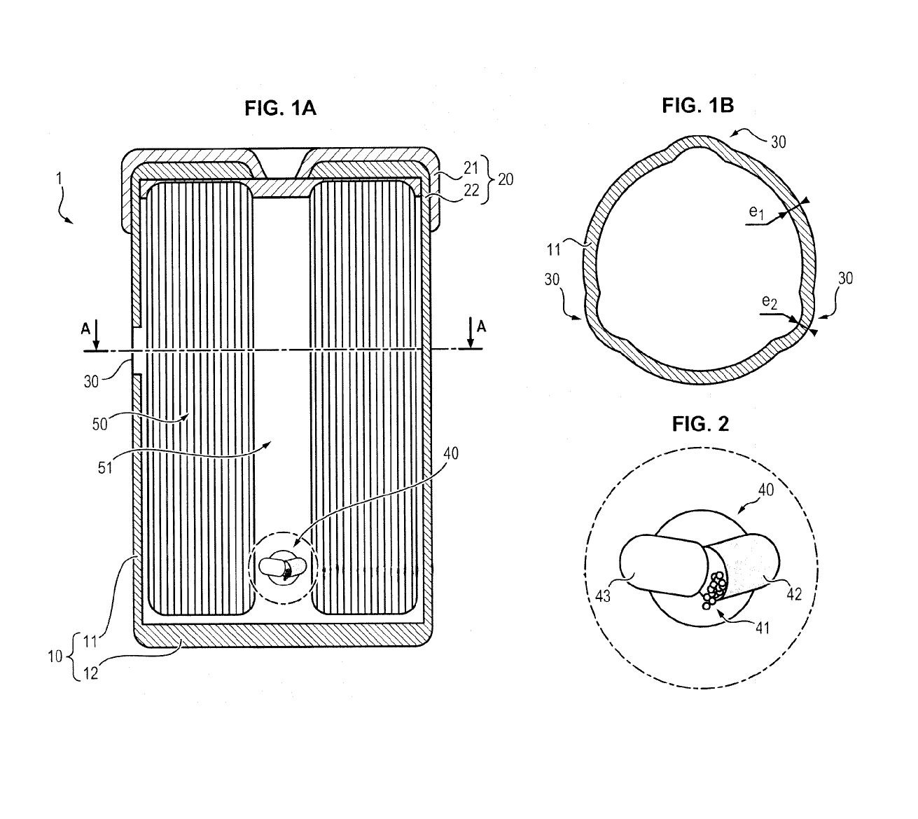

With reference to FIG. 1, an example of an assembly 1 was illustrated. This assembly 1 includes an envelope including:
a body 10 containing a liquid electrolyte and an electrical energy storage element 50, and
one or several lid(s) 20 intended to close the body 10 for making the assembly 1 leak proof.

### 1.1. Element

The element 50 is for example a spool consisting of complexes and separators which are substantially planar and jointly wound in turns in order to form the spool.

By “complex” in the scope of the present invention, is meant a stack including at least two distinct layers, notably a cathode layer and an electrolyte layer.

This element is immersed in a liquid electrolyte contained in the envelope. The electrolyte may be an ionic liquid.

Alternatively, the electrolyte may comprise a solvent (either organic or not) and a salt. The salt may be an ammonium salt such as TEABF₄, TEMABF₄, lithiated salts (LIPF₆, LITFSI, LiFSI, LiBF₄, LiCIO₄ . . . ), spyro salts (SBP-BF4 5-azoniaspiro(4-4) nonane tetrafluoroborate), sulphates (Na₂SO₄, K₂SO₄, H₂SO), KOH, NaOH). The solvent may be water, acetonitrile, cyclic alkylcarbonates (propylene carbonate, ethylene carbonate . . . ), acyclic alkylcarbonates (DMC, DEC, . . . ), sulfones (sulfolane . . . ).

### 1.2. Envelope

The body 10 of the envelope comprises a side wall 11, optionally cylindrical.

In certain alternative embodiments, the body 10 comprises a bottom 12 at one of its ends and is open at its other end so as to allow insertion of the element 50 into the body 10. Preferably, the external face of the bottom 12 is substantially planar in order to allow the welding of a strip in any point of its surface.

In other alternative embodiments, the body 10 is open at both of its ends. In every case, each open end of the body 10 is closed by a lid 20.

The envelope 10 may comprise a mechanically embrittled portion 30. During an increase in the pressure inside the assembly beyond a pressure threshold, the embrittled portion 30 is designed so as to break in order to allow the gas contained in the assembly 1 to escape.

The embrittled portion 30 may be a thinned portion of the envelope, i.e. a portion for which the thickness is less than the other regions of the envelope 10. Alternatively, the embrittled portion 30 may be a boss or an edge forming an area for initiating the breakage.

This embrittled portion 30 may extend on the bottom 12 or on the side wall 11 of the body 10. In the embodiment illustrated in FIG. 1, the embrittled portion 30 extends over a portion of the circumference of the side wall 11.

The embrittled portion 30 may be formed by punching the side wall 11 (or the bottom 12) of the envelope 10 in a plurality of points (notably three or four) distributed over the perimeter of the side wall 11. An additional boss of the punch is then formed and the thickness e2 of the wall at this boss is locally reduced relatively to the thickness e1 of the wall at the remainder of the assembly because of the deformation induced by the formation of the boss. An axial section of the envelope was illustrated in FIG. 1B of a portion including bosses, which illustrates this configuration.

### 1.3. Lid

Each lid 20 comprises a covering wall 21 for closing the open end of the body.

The covering wall 21 comprises two faces:
an internal face intended to be connected to the element 50, and
an external face intended to be bound, notably by welding, to a strip ((not shown).

Preferably, the external face of the lid 20 is substantially planar. More specifically, this external face is preferably without any pin in its centre and any edge at its periphery. This gives the possibility of maximizing the surface area of the lid 20 which may be welded to the strip.

Each lid 20 may also comprise a skirt 22 at the periphery of the covering wall 21, this skirt 22 being intended to partly cover the side wall 11 of the envelope 10.

1.4. Pressure-raising accelerator

The storage assembly also comprises a pressure-raising accelerator 40.

The goal of the accelerator 40 is to generate overpressure inside the assembly 1 when the internal temperature of the latter exceeds a temperature threshold.

The accelerator 40 generally comprises a sealed housing containing an overpressure agent, the release of the overpressure agent generating overpressure in the assembly.

Different types of accelerator may be used.

For example, the accelerator may be an “active” system and comprise:
a cartridge (i.e. a sealed housing) containing compressed air (i.e. an overpressure agent) and closed with a lid which may be displaced between an open position and a closed position,
a temperature sensor for measuring the temperature inside the assembly,
a controller for:
   comparing the temperature measured by the sensor with a temperature threshold, and for
   controlling the opening of the lid when the measured temperature exceeds the temperature threshold.

Preferably, the accelerator 40 may be a “passive” system such as the accelerator illustrated in FIG. 2, more simple to apply and less costly to make.

This accelerator 40 comprises a hollow capsule (delimiting the sealed housing) containing one or several reagent(s) (i.e. overpressure agent).

This or these reagent(s) 41 trigger a chemical reaction when they are released in the assembly 1 in order to generate a gas. It is the generation of this gas which induces overpressure inside the assembly 1.

### 1.4.1. Capsule

The capsule includes a head 42 and a body 43 fitted into each other. With reference to FIG. 2, the head 42 (respectively the body 43) is cylindrical, open at one end and includes a hemispherical bottom at its other end.

Preferably, the capsule is made in a material having a melting temperature:
greater than the maximum operating temperature of the assembly,
less than a critical temperature from which the mechanical strength of the parts of the assembly is degraded.

Notably, the capsule may be made up in a material for which the melting temperature is comprised between 120° C. and 140° C., such as for example:
a thermoplastic, such as polypropylene (PP), polyethylene (PE), polycarbonate (PC), polystyrene (PS), polyoxymethylene (POM), or polyamide (PA),
a thermosetting plastic, such as polyester or polyurethane, or
an elastomer.

Preferably, the capsule may comprise at least one area with limited thickness which gives the possibility of obtaining an opening of the capsule in said area.

In certain embodiments, the hollow capsule contains a reagent 41 selected for reacting with a component containing the assembly, such as for example the electrolyte contained in the assembly (or further the active material of the electrodes of the element).

In other embodiments, the hollow capsule contains several reagents 41 intended to react together once in solution. This has the advantage of having available an accelerator which may be used in each type of electrolyte (aqueous, organic electrolyte) and then the triggering of the chemical reaction does not depend on the composition of the electrolyte.

These reagents intended to react together are for example:
inert in the solid state, and
active when they are dissolved in a solution.

In this case, the reagents 41 are stored in the solid form in the capsule, their release inducing their dissolution in the electrolyte so that they react together for generating a gas.

It is also possible to design the capsule so that it contains several housings each containing one reagent. Provision may also be made for several capsules, each comprising a reagent.

It will be noted that in the embodiment of FIG. 1A, the capsule is placed in a central recess 51 of the storage assembly, which corresponds to a space anyhow empty, required because of the winding of the storage element 50. The dimension of the accelerator 40 is thus minimum since it does not force an increase in the volume of the assembly 1.

The shape of the capsule is not limited to what has been described. The capsule for example may form a cylindrical bar with a height equal to the wound element 50 and which is used for winding the element. This capsule may then be more rigid, notably solid over a portion of its height. It would comprise whatever the case, a compartment for storing the overpressure agent.

### 1.4.2. Reagents

The reagent(s) contained in the capsule allow(s) generation of a gas, preferably nonpolluting—such as dihydrogen (H₂), or carbon dioxide (CO₂) or dinitrogen (N₂).

The reagent(s) may be stored in the capsule in liquid form. For example, the reagent may be water, this water reacting with an ammonium salt of the electrolyte, such as TEABF₄, in order to form dihydrogen when it is released into the electrolyte.

The reagent(s) may also be stored in the capsule in solid form. For example, the reagents may consist in a mixture including:
A first reagent having a COOH group (carboxylic acid)
General formula: R—COOH;
A second soluble reagent and the dissolution of which allows formation of:
   a bicarbonate ion (HCO₃—)—i.e. sodium bicarbonate (NaHCO₃) or calcium bicarbonate (CaHCO₃) or potassium carbonate (KHCO₃) or lithium bicarbonate (LiHCO₃), etc.
   General formula of the reagent: XHCO₃;
   a carbonate ion (CO₃²⁻)—i.e. sodium carbonate (Na₂CO₃) etc.,
   General formula of the reagent: X₂CO₃;

These reagents, once dissolved, trigger one of the following chemical reactions:

X⁺+HCO₃⁻+R—COOH→CO₂+H₂O+R—COO—X⁺,

2X⁺+CO₃²⁻+R—COOH→CO₂+H₂O+2R—COO—X⁺.

The gas generated by these chemical reactions is therefore carbon dioxide CO₂.

### 2. Operating Principle

The operating principle of the assembly according to the invention will now be described in more detail with reference to an accelerator 40 consisting of a capsule containing a mixture of powders of organic acids and of carbonates or bicarbonates.

When the assembly is exposed to a fire, its internal temperature increases. The capsule containing the reagents attains its melting temperature. The capsule starts to melt, releasing the reagents into the electrolyte. These reagents dissolve in the electrolyte and trigger a chemical reaction inducing the generation of carbon dioxide CO₂.

The overpressure caused by the generation of carbon dioxide CO₂ generates a thrust force on the envelope 10 directed towards the outside of the assembly. The thrust force causes breaking of the embrittled portion. The breaking of the embrittled area forms a ventilation for the passage of fluids between the inside and the outside of the assembly.

Accordingly, the gases contained in the assembly escape on the outside of the latter, and the internal pressure of the assembly becomes equal to atmospheric pressure.

The risk of explosion of the assembly is thereby avoided.

### 3. Conclusions

By means of the invention described above, it is therefore possible to avoid risks of explosion of an assembly by accelerating its opening when it is subject to extreme heat.

The reader will have understood that many modifications may be brought to the assembly shown above without materially departing from the new teachings described here.

For example in the foregoing description, the embrittled portion extended on the external envelope of the assembly. Alternatively, the embrittled portion may extend on the (or on one) of the lid(s).

Therefore, all the modifications of this type are intended to be incorporated inside the scope of the appended claims.

1. An electrical energy storage assembly comprising:
an envelope including:
a body having at least one side wall and at least one open end,
at least one lid for closing said at least one open end of the body
at least one energy storage element placed inside the envelope,
an electrolyte solution also inside the envelope, and wherein the storage assembly further comprises:
means for locally breaking the envelope when the pressure inside the envelope is greater than a pressure threshold, and
an pressure-raising accelerator for generating overpressure inside the assembly when the temperature inside the assembly is greater than a temperature threshold, the pressure raising accelerator comprising at least one sealed housing, each housing containing at least one overpressure agent, said sealed housing(s) being configured for releasing the overpressure agent when the temperature inside the assembly is greater than the temperature threshold and at least one wall of said housing being designed in a material for which the melting temperature is substantially equal to the temperature threshold.

2. The assembly according to claim 1, wherein the temperature threshold is comprised between 120° C. and 140° C.

3. The assembly according to claim 1, wherein the pressure-raising accelerator is able to trigger a chemical reaction generating a gas in the assembly when the temperature inside the assembly is greater than the temperature threshold.

4. The assembly according to claim 1, wherein the pressure-raising accelerator is positioned inside the envelope.

5. The assembly according to claim 4, wherein the storage element placed in the envelope is wound so as to have a cylindrical shape and to have a central recess, the accelerator being placed in the recess.

6. The assembly according to claim 1, wherein said at least one wall delimiting said or at least one of the housings is in a plastic material selected from polypropylene, polyethylene, polycarbonate, polystyrene, polyoxymethylene, polyamide, polyester, polyurethane or an elastomer.

7. The assembly according to claim 6, wherein said overpressure agent(s) is (are) able to generate a gas selected from dihydrogen (H₂), carbon dioxide (CO₂) or dinitrogen (N₂) when they are released from the sealed housing(s).

8. The assembly according to claim 7, wherein said overpressure agent form reagents selected for reacting with the electrolyte of the assembly.

9. The assembly according to claim 8, wherein the overpressure agent is water (H₂O) and the electrolyte comprises an ammonium salt in solution with which the water reacts for forming dihydrogen (H₂).

10. The assembly according to claim 1, comprising a plurality of overpressure agents, arranged in a single housing or in respective housings, and forming a plurality of reagents selected for reacting together when they are placed in solution.

11. The assembly according to claim 10, wherein the plurality of overpressure agents comprises a first reagent including a carboxylic acid (R—COOH) and a second reagent based on a carbonate (X₂CO₃) or bicarbonate (XHCO₃).

12. The assembly according to claim 1, wherein the means for locally breaking the envelope comprise a mechanically embrittled area intended to break when the pressure inside the assembly is greater than the pressure threshold.

13. The assembly according to claim 12, wherein the mechanically embrittled area is a boss or an edge or a region of the assembly, the thickness (e2) of which is less than the thickness (e1) of the other regions of the assembly.

14. The assembly according to claim 1, wherein the means for locally breaking the envelope are localized on the side wall of the envelope.

15. An electrical energy storage module including a casing, wherein it comprises at least one electrical energy storage assembly according to claim 1.

16. A method for manufacturing an electrical energy storage assembly comprising:
an envelope including:
a body having at least one side wall and at least one open end,
at least one lid for closing said at least one open end of the body
at least one energy storage element placed inside the envelope,
an electrolyte solution also placed inside the envelope, and wherein it comprises the steps of:
associating a pressure-raising accelerator with the assembly, notably by positioning the accelerator in the envelope, the accelerator giving the possibility of generating overpressure inside the assembly when the temperature inside the assembly is greater than a temperature threshold, the accelerator comprising at least one sealed housing, each housing containing at least one overpressure agent, said sealed housing(s) being configured for releasing the overpressure agent(s) when the temperature inside the assembly is greater than the temperature threshold and at least one wall of said housing being designed in a material, the melting temperature of which is substantially equal to the temperature threshold, and
forming means for locally breaking the envelope when the pressure inside the envelope is greater than a pressure threshold, notably by forming a mechanically embrittled area on the envelope.
